(19) United States
(12) Patent Application Publication
(10) Pub. No.: US 2005/0200457 A1
(43) Pub. Date: Sep. 15, 2005

(54) Inventory transport device with integrated RFID reader

(76) Inventors: Raj Bridgelall, Mount Sinai, NY (US); Michael Knox, Manhasset, NY (US); Hal Charych, East Setauket, NY (US); Mark Duron, East Patchogue, NY (US); Richard T. Knadle JR., Dix Hills, NY (US)

Correspondence Address: INGRASSIA FISHER & LORENZ, P.C., 7150 E. CAMELBACK, STE. 325, SCOTTSDALE, AZ, 85251, US

(21) Appl. No.: 10/799,129

(22) Filed: Mar. 11, 2004

(51) Int. Cl. H04Q 5/22

(52) U.S. Cl. 340/10.3

(57) ABSTRACT

An apparatus is provided for an inventory transport device having a fixed section and a movable section. The apparatus comprises a RFID reader device mounted on the movable section; and a RFID power device mounted on the fixed section. The RFID power device provides power to the RFID reader device without physical contact.

### FIELD OF THE INVENTION

This invention relates to the field of automated data capturing and more specifically to an inventory transport device with integrated RFID reader.

### BACKGROUND OF THE INVENTION

Asset tracking is of great importance to many companies. For example, retailers want to track an asset, such as cartons of shampoo or cases of canned cream corn from the supplier, through the supply chain and to the stores. Tracking increases the efficiency by providing knowledge regarding how much stock of goods are available and when more stock is needed. Better tracking systems often times lead to greater savings.

One commonly used asset tracking system is the well-known bar code system. Products are assigned a universal product code and an associated bar code. The product can be identified by using a bar code scanner to read the bar code. While bar code systems are useful, they also have certain limitations. For example, bar codes cannot encode a great deal of information. Bar code readers have a very limited range. Also, the bar code needs to be in the line of sight of the bar code reader for the bar code to be read.

To solve some of these drawbacks, Radio Frequency Identification (RFID) systems for asset tracking have been proposed. In an RFID system, transponders (commonly referred to as tags) are located on the asset to be tracked. An RFID reader (or interrogator), typically contains a radio frequency (RF) transceiver, when triggered, sends a radio frequency transmission (an interrogation) towards a tag. The tag that receives an interrogation responds to the interrogation. In one embodiment, the tag back scatter modulates the received signal in response to the interrogation.

The tags can either be active tags, which may transmit continuously or periodically, or passive tags, which transmit in response to an interrogation. Active tags are typically battery powered. Passive tags are typically powered without contact by using the electrical or mechanical field generated by the reader.

In a warehouse setting, tags may be applied to assets, cases of assets and/or collection of cases of assets. Some of these assets may be located on high shelves or racks in the warehouses. This may make it difficult for the user to track assets because the tags of the assets are not visible or the tags are too far from the reader. What is needed is an inventory transport device with an integrated RF transceiver.

### BRIEF SUMMARY OF THE INVENTION

In one embodiment of the present invention, an apparatus is provided for an inventory transport device having a fixed section and a movable section. The apparatus comprises a RFID reader device mounted on the movable section; and a RFID power device mounted on the fixed section and operable to provide the RFID reader device power without physical contact.

In another embodiment of the present invention, an apparatus is provided for a RFID reader for use in an inventory transportation device. The RFID reader assembly comprises a RFID transceiver configured to broadcast interrogations and receive replies; and a power source coupled to the RFID transceiver, the power source configured to store energy received from a contactless power supply.

### BRIEF DESCRIPTION OF THE DRAWINGS

The present invention will hereinafter be described in conjunction with the following drawing figures, wherein like numerals denote like elements, and wherein:

FIG. 1 illustrates an exemplary forklift in accordance with the teachings of the present invention;

FIG. 2 is a block diagram illustrating an embodiment of a RFID power assembly in accordance with the teachings of the present invention;

FIG. 3 is a block diagram illustrating an embodiment of a RFID reader assembly in accordance with the teachings of the present invention;

FIG. 4 is a block diagram illustrating an embodiment of a user terminal in accordance with the teachings of the present invention; and

FIG. 5 is illustrates a forklift in accordance with the teachings of the present invention operating in a warehouse.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention. While an embodiment of the present invention discusses the use of the invention with a forklift, any inventory transport device can be used.

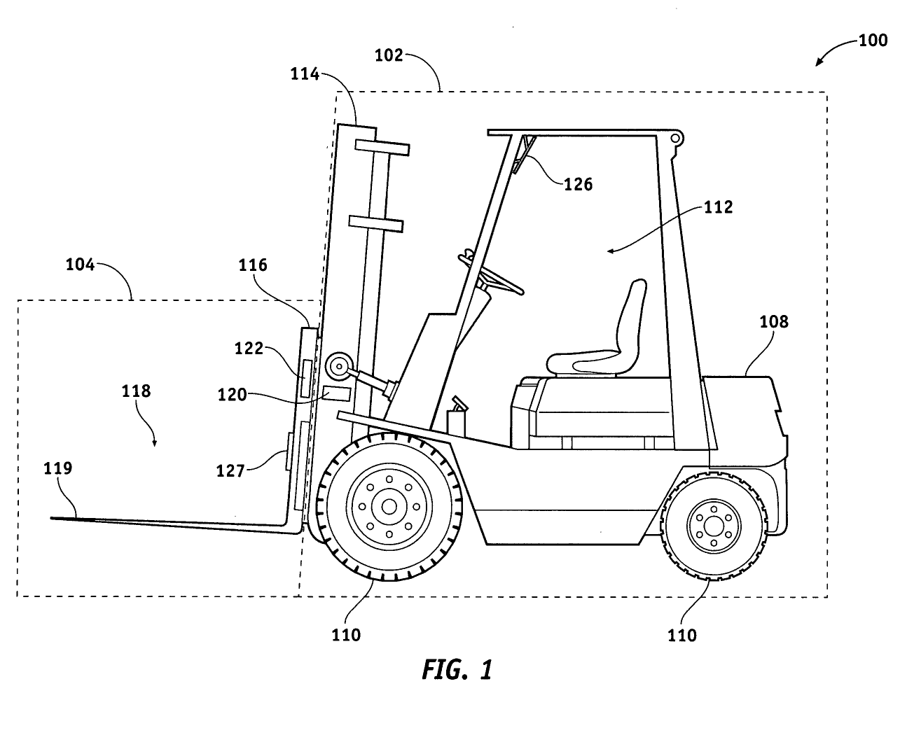

An exemplary inventory transport device, in this embodiment a forklift 100 in accordance with the teachings of the present invention, is illustrated in FIGS. 1-4. Forklift 100 can be used to transport objects that are bulky or heavy or both bulky and heavy from one place to another. For example, forklift 100 can move pallets containing a great number of goods. Forklift 100 comprises a fixed portion 102 and a moveable portion 104. Moveable portion 104 typically moves up and down in a vertical direction with respect to the fixed portion 102. Fixed portion 102 is fixed as to vertical movement; fixed portion 102 does move as any wheeled vehicle would normal move. Fixed portion 102 comprises a chassis 108, which is the body of the forklift, coupled to wheels 110 which allow the forklift 100 to move. A cab 112 is mounted on the chassis 108 and contains the controls of the forklift and provides an area for the operator to sit. Affixed to one end of the fixed portion 102 is a mast section 114.

Moveable portion 104 includes a cage section 116 coupled to a fork section 118. Fork section typically comprises two prongs 119. In one embodiment, cage section 116 (and therefore the moveable portion 104), which is mounted to mast section 114, may move up and down an approximately vertical fashion. Additionally, fork section 118 maybe adjustable such that each of the prongs 119 that make up the fork section 118 can be moved towards or away from each other or be adjusted angularly.

Forklifts as discussed so far are well known in the art. Forklifts are available from a number of manufacturers including Nissan Corp. of America.

In addition to the previously described well known forklift parts, forklift 100, in accordance with the present invention, further includes an RFID power assembly 120, a RFID reader assembly 122 coupled to one or more RFID antennas 127 and an user terminal 126. While FIG. 1 shows an exemplary placement, the placement of RFID power assembly 120 and RFID reader assembly 122 can be changed. RFID power assembly can be mounted anywhere on the fixed portion 102 and the RFID reader assembly can be mounted anywhere on the moveable portion 104 as long as the RFID power assembly 120 can provide power to the RFID reader assembly 122.

RFID power assembly 120, in one embodiment, provides power to RFID reader assembly 122 without physically contacting the RFID reader assembly 122. This can be done through any well known contactless power transferring techniques such as inductive coupling. In inductive coupling, the source of power produces a time varying current in an antenna (which acts like an inductor). The power receiving device also has an antenna (which acts like a second inductor). The time varying current in the first inductor induces a voltage in the second inductor due to mutual inductance.

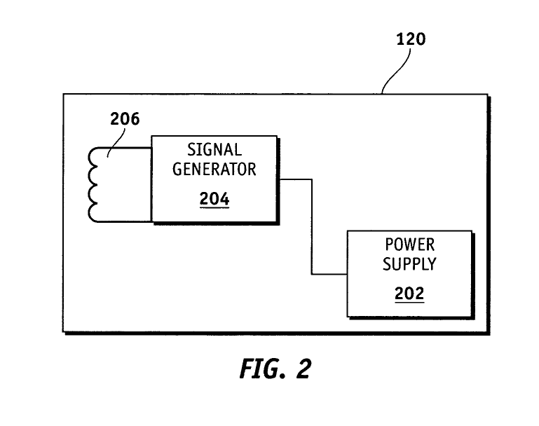

A block diagram of an exemplary RFID power assembly 120 is shown in FIG. 2. In the exemplary embodiment of FIG. 2, RFID power assembly 120 comprises a power supply 202, a signal generator 204 and an antenna 206.

Power supply 202 provides power for the RFID power assembly 120. The power supply 202 may be internal to RFID power assembly 120, such as an internal battery or generator. Alternatively, power supply 202 may be external to RFID power assembly 120 and provided to RFID power assembly 120 via a cable or cord. For example, power supply 202 may be the battery of the forklift, the alternator of the forklift, a generator mounted on the forklift or any other source of electrical power.

Signal generator 204 is any circuit capable of receiving an input from a power source and producing a signal for presentation to an antenna. Depending on the power supply 202 the signal generator 204 may convert direct current input into alternating current output. Signal generator 204 may also prepare the signal for presentation to the antenna 206.

Antenna 206 receives the signal from signal generator 204. The signals, in one embodiment, comprise an alternating current. The antenna 206 can be any antenna capable of inducing a voltage in another antenna. In this example, the antenna 206 will induce a voltage in an antenna of RFID reader assembly 122 due to mutual inductance.

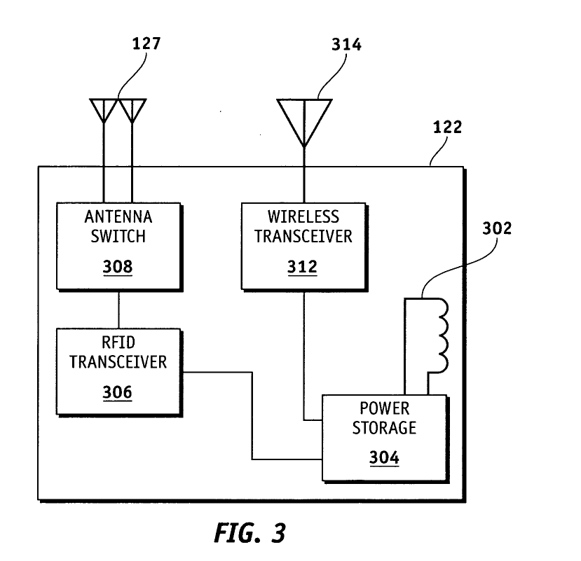

RFID reader assembly 122 operates as part of an RFID system by sending out interrogations to tags and receiving and processing replies from the tags in order to locate and/or read RFID tags. As seen in FIG. 3, RFID reader assembly 122 comprises a power antenna 302 coupled to a power storage unit 304. Power storage unit 304 provides power for and is coupled to the RFID transceiver 306. RFID transceiver 306 is coupled to one or more RFID antennas 127 via an antenna controller 308.

Power antenna 302, in one embodiment, receives the induced voltage from antenna 206 of the RFID power assembly 120. Power antenna 302 can be an antenna suitable for use in a mutual inductive system.

Power storage unit 304 receives the induced voltage and stores the energy for use in powering the components of the RFID transceiver 306. In one embodiment power storage unit 304 is one or more rechargeable batteries, such as nickel metal hydride or lithium ion rechargeable batteries. The induced energy from the coupling of the antennas charges the battery. Alternatively, power storage unit 304 can be any other energy storage device such as a series of capacitors.

In one embodiment, RFID reader assembly 122 has its own, permanent power supply and does not rely on the RFID power assembly 120. In this embodiment, the RFID transceiver 306 can be powered by batteries or a self contained generator.

RFID transceiver 306 sends interrogations to tags and receives replies from those tags. RFID transceiver 306 is of known design and is discussed in the RFID Handbook by Klaus Finkenzeller, hereby incorporated by reference.

RFID transceiver 306 sends interrogations via RFID antenna 127. In one embodiment, when there is more than one RFID antenna 127, an antenna controller 308 may be included. The antenna controller 308 switches the RFID transceiver 306 between each RFID antenna 127. In this manner, multiple antennas can be multiplexed to one RFID transceiver 306.

RFID antennas 127 can be any antenna suitable for sending interrogations to RFID tags and receiving replies from RFID tags. In one embodiment of the present invention, the RFID antennas 127 are mounted on the moveable portion 104 of the forklift 100. The antennas can be mounted, etched, printed or other affixed to the fork section 118 or to the cage section 116 or both, depending on the needs of the operator of the forklift. Alternatively, the RFID antennas 127 can be mounted on the fixed portion 102. However, by mounting the RFID antennas on the moveable portion 104, there are no wires between the moveable portion 104 and the fixed portion 102.

In another embodiment, RFID reader assembly 122 is mounted on the fork section 118 in a hermetically sealed unit. The hermetically sealed unit also contains the RFID antenna 127. The RFID antenna 127, in this embodiment, is mounted in the unit such that it will radiate a pattern out to read pallet tags. An advantage of this embodiment is that a pallet tag reader can be provided on a forklift without the need to mount external antenna.

RFID reader assembly 122, in one embodiment, also comprises a wireless transceiver 312 coupled to the power supply and wireless antenna 314. Wireless transceiver 312 allows communication from the RFID reader assembly 122 to an external device, such as a wireless network access point (not pictured) or to the user terminal 126, if provided. Wireless transceiver 312 may be compatible with wireless local network standards such as the well known IEEE standards 802.11a, 802.11b or 802.1 μg; however, any wireless protocols can be used. In one embodiment, wireless transceiver 312 communicates using a short range wireless protocol, such as the BLUETOOTH wireless technology standard, with the user terminal 126. Wireless transceivers are well known and manufactured by companies such as Analog Devices of Norwood, Mass.

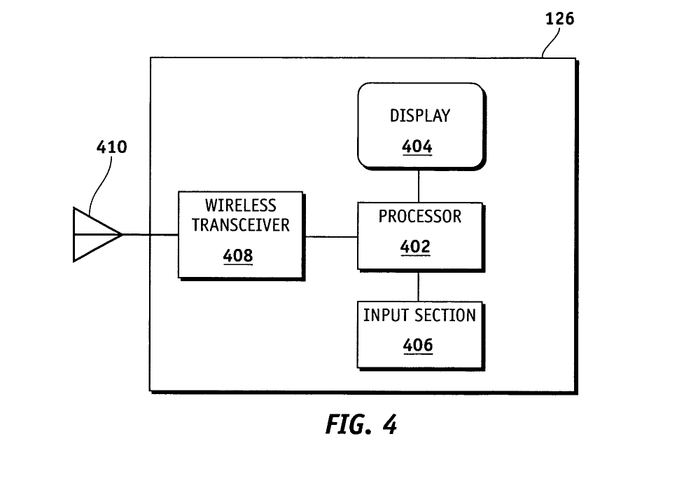

User terminal 126 is any device that provides an interface between a user and the RFID assembly. In one embodiment of the present invention and as illustrated in FIG. 4, user terminal 126 comprises a processor 402, a display 404, an input section 406 and a wireless transceiver 408.

Processor 402 controls the data handling for the user device as well as the input and output of the user device. Processor 402 can be any processor designed for data processing such as those manufactured by Hitachi, Microchip, IBM and the like.

Display 404 provides a visual output to the user of the user terminal 126. Display 404, in one embodiment, is an LCD display, although any other display technology such as plasma displays or CRT displays can be utilized. In one embodiment, display 404 is a touch sensitive display that responds to the user touch of certain areas of the display to send commands to the RFID assembly.

Input section 406 receives inputs from the user to control the operation of the RFID assembly. Input section 406 can be a series of control buttons, such as a button labeled “up” that, when manipulated, causes the moveable portion 104 of the forklift 100 to rise. Alternatively, input section 406 can be a keyboard, a voice recognition system, a touch sensitive screen or any other device that accepts inputs from a user.

Input section 406 may further comprise a wireless headphone that can be worn by the user to enable the user to provide voice commands to the user terminal 126. The wireless headphone can be included as part of user terminal 126 and coupled to user terminal 126 via a wired or wireless connection. The wireless connection can utilize any wireless protocol such as short range wireless protocol such as the Bluetooth wireless technology standard or wireless LAN protocols as promulgated in the IEEE 802.11 standards. In one embodiment, the headset can be used to communicate with other individuals by sending conversations over a network using known voice-over-IP techniques.

Wireless transceiver 408 allows communication from the user terminal 126 to RFID reader assembly 122 or any other external device such as a wireless network access point. Wireless transceiver 408 may be compatible with wireless LAN standards such as the well known IEEE standards such as 802.11a, 802.11b or 802.11g; however, any wireless protocols can be used. In one embodiment, user terminal 126 communicates with the wireless transceiver 312 using the BLUETOOTH wireless technology standard (short-range wireless).

In operation, when the RFID reader assembly 122 is, at least part of the time, proximate to the RFID power assembly 120, the power storage unit 304 of the RFID reader assembly 122 is charged without any contact being made between the RFID reader assembly and the RFID power assembly. The absence of cables between the RFID reader assembly 122 and the RFID power assembly 120 allows for easier installation of these components on the forklift 100. Also, since there are no cables between the RFID reader assembly 122 and the RFID power assembly 120, either one of those assemblies can be easily replaced.

In one embodiment, RFID power assembly 120 is fixed on the chassis such that when the moveable portion 104 of the forklift 100 is in a rest position (the moveable portion is in the fully down position) the RFID power assembly 120 is close enough to the RFID reader assembly 122 that the power storage unit 304 of the RFID reader assembly 122 can be charged. As the moveable portion moves up and away from the RFID power assembly, charging stops.

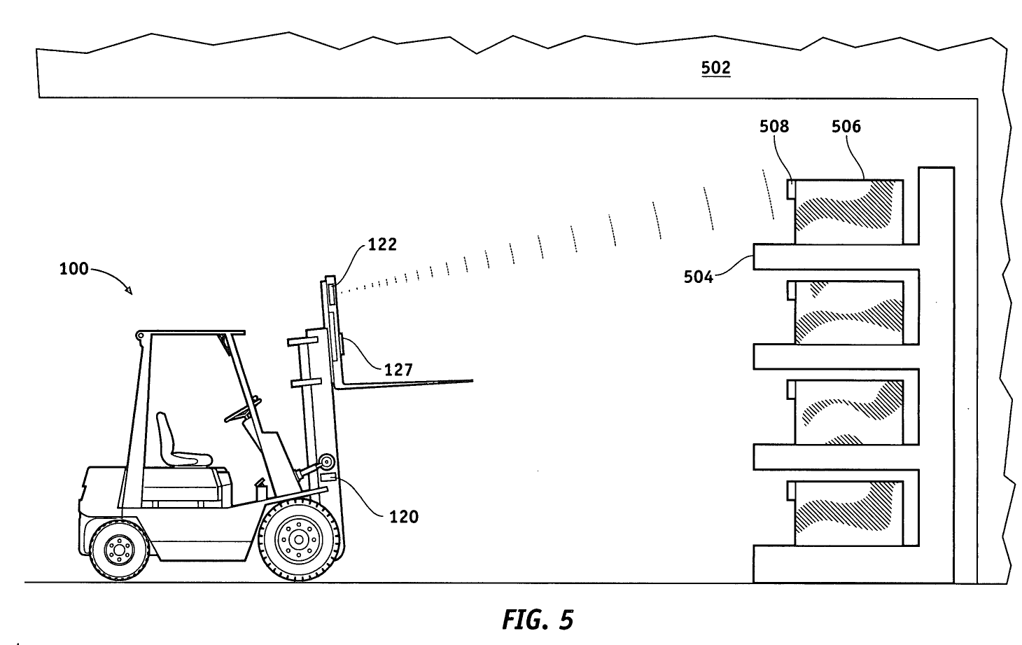

On use of the present invention is as part of an inventory control program. With reference to FIG. 5, forklift 100 is operating in a warehouse 502 that includes one or more shelves. Each of the shelves may have packages 506 stored on the shelves. RFID tags 508 are mounted on the package. The RFID tags 508 may, in one embodiment, store information about the content of the package 506.

The operator of the forklift 100 may, in one embodiment, be looking for a certain package 506. In order to better read RFID tags 508 on shelves 504, the operator, through the user terminal 126, issues a command for the moveable portion 104 of forklift 100 to move upwards. The RFID reader assembly 122 is then better able to read the RFID tags 508 that are placed on higher shelves 504. The forklift 100 can move about the warehouse 502 looking for particular RFID tags. In one embodiment, there is the possibility that an interrogation from the RFID reader assembly 122 can be replied to by more than one RFID tag 508. In that case, known techniques such as measuring the relative signal strength of received signals can be used to determine which reply can be associated with the closest RFID tag 508.

While the forgoing discussed the use of forklifts with the present invention, the teachings of the present invention can be applied to all types of inventory transport devices having a fixed section and a moveable section, including palette trucks and walkie stackers.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

1. An inventory transport device having a fixed section and a movable section comprising:
a RFID reader device mounted on the movable section; and
a RFID power device mounted on the fixed section and operable to provide the RFID reader device power without physical contact.

2. The device of claim 1 further comprising a user terminal mounted in the fixed section, the user terminal configured to accept user input to control the RFID reader device and the movable section.

3. The device of claim 2 wherein the user terminal and the RFID reader communicate wirelessly.

4. The device of claim 3 wherein the user terminal and the RFID reader device communicate wirelessly using a wireless local area network protocol.

5. The device of claim 3 wherein the user terminal and the RFID reader device communicate using a short range wireless protocol.

6. The device of claim 1 further comprising one or more RFID antennas mounted on the moveable section.

7. The device of claim 6 wherein at least one of the one or more RFID antennas is mounted on a fork of the moveable section

8. The device of claim 6 wherein the one or more RFID antennas are inside a hermetically sealed container with the RFID transceiver.

9. The device of claim 8 wherein the hermetically sealed box is mounted on a fork of the moveable section.

10. The device of claim 6 wherein the one or more RFID antennas are coupled to an antenna switch configured to select which of the one or more RFID antennas to use.

11. The device of claim 1 wherein the inventory transport device is a forklift.

12. The device of claim 1 wherein the RFID power device provides power via inductive power transfer.

13. The device of claim 12 wherein the RFID power device further comprises an internal power supply.

14. The device of claim 12 wherein the RFID power device is coupled to an external power supply.

15. The device of claim 14 wherein the external power supply is a battery located in the inventory transfer device.

16. A RFID reader for use in an inventory transport device comprising:
a RFID transceiver configured to broadcast interrogations and receive replies; and
a power source coupled to the RFID transceiver, the power source configured to store energy received from a contactless power source.

17. The RFID reader of claim 16 wherein the inventory device comprises a moveable section and a fixed section, the RFID transceiver mounted on the moveable section.

18. The RFID reader of claim 16 further comprising one or more RFID antennas mounted on the moveable section.

19. The RFID reader of claim 16 wherein at least one of the one or more RFID antennas is mounted on a fork of the moveable section

20. The RFID reader of claim 16 wherein the one or more RFID antennas are inside a hermetically sealed container with the RFID transceiver.

21. The RFID reader of claim 20 wherein the hermetically sealed box is mounted on a fork of the moveable section.

22. The RFID reader of claim 16 wherein the one or more RFID antennas are coupled to an antenna switch configured to select which of the one or more RFID antennas to use.

23. The RFID reader of claim 16 wherein the inventory transport device is a forklift.

24. The RFID reader of claim 16 wherein the RFID power device provides power via inductive power transfer.

25. The RFID reader of claim 24 wherein the RFID power device further comprises an internal power supply.

26. The RFID reader of claim 24 wherein the RFID power device is coupled to an external power supply.

27. The RFID reader of claim 26 wherein the external power supply is a battery located in the inventory transfer device.
